(19) United States
(12) Patent Application Publication
(10) Pub. No.: US 2024/0380224 A1
(43) Pub. Date: Nov. 14, 2024

(54) CONTROL DEVICE AND CONTROL METHOD

(71) Applicant: TOYOTA JIDOSHA KABUSHIKI KAISHA, Toyota-shi (JP)

(72) Inventors: Makoto AKAHANE, Yokohama-shi (JP); Yu NAGATA, Tokyo (JP); Tomokazu MAYA, Nagoya-shi (JP); Masaaki TOMIYA, Urayasu-shi (JP); Yuko MINETA, Tokyo (JP); Kayo TSUMOTO, Nisshin-shi (JP); Shinichi NIWA, Nagakute-shi (JP); Satoshi KOMAMINE, Nagoya-shi (JP)

(73) Assignee: TOYOTA JIDOSHA KABUSHIKI KAISHA, Toyota-shi (JP)

(21) Appl. No.: 18/418,613

(22) Filed: Jan. 22, 2024

(30) Foreign Application Priority Data
May 9, 2023 (JP) 2023-077478

(51) Int. Cl. H02J 7/00; G05D 1/656; G05D 105/00

(52) U.S. Cl. CPC H02J 7/0042; G05D 1/656; G05D 2105/00

(57) ABSTRACT

The control device acquires information regarding an event held within a certain area, and based on the acquired information, the power supply has the function of supplying power to electronic devices used by the user from among multiple locations within the area. The control unit includes a control unit that determines a location to dispatch the mobility and performs processing to dispatch the power supply mobility to the determined location.

### CROSS-REFERENCE TO RELATED APPLICATION

This application claims priority to Japanese Patent Application No. 2023-077478 filed on May 9, 2023, incorporated herein by reference in its entirety.

### BACKGROUND

### 1. Technical Field

The present disclosure relates to a control device and a control method.

### 2. Description of Related Art

Japanese Unexamined Patent Application Publication No. 2021-121885 (JP 2021-121885 A) discloses that a charging vehicle provided with a charging battery moves to the position of a user vehicle and charges a battery that serves as a drive source for the user vehicle as a charging service.

### SUMMARY

Conventional charging services do not meet the charging needs that exist in an area where events are to be held such as an event site.

An object of the present disclosure is to meet the charging needs that exist in an area where events are to be held.

A control device according to the present disclosure includes a control unit that acquires information about events to be held within a certain area, determines a location to which power supply mobility is to be dispatched from among a plurality of locations within the area based on the acquired information, and dispatching the power supply mobility to the determined location.

The power supply mobility is provided with a function of supplying power to an electronic device used by a user.

A control method according to the present disclosure includes:
acquiring, by a control unit, information about events to be held in a certain area;
determining, by the control unit, a location to which power supply mobility is to be dispatched from among a plurality of locations within the area based on the acquired information, the power supply mobility being provided with a function of supplying power to an electronic device used by a user; and performing, by the control unit, a process of dispatching the power supply mobility to the determined location.

According to the present disclosure, it is possible to meet the charging needs that exist in an area where events are to be held.

### BRIEF DESCRIPTION OF THE DRAWINGS

Features, advantages, and technical and industrial significance of exemplary embodiments of the disclosure will be described below with reference to the accompanying drawings, in which like signs denote like elements, and wherein:

FIG. 1 is a diagram showing the configuration of a mobility dispatch system according to an embodiment of the present disclosure;

FIG. 2 is a block diagram showing the configuration of a control device according to an embodiment of the present disclosure; and

FIG. 3 is a flowchart showing the operation of the control device according to the embodiment of the present disclosure.

### DETAILED DESCRIPTION OF EMBODIMENTS

Hereinafter, an embodiment of the present disclosure will be described with reference to the drawings.

In each drawing, the same or corresponding portions are denoted by the same reference signs. In the description of the present embodiment, description of the same or corresponding components will be appropriately omitted or simplified.

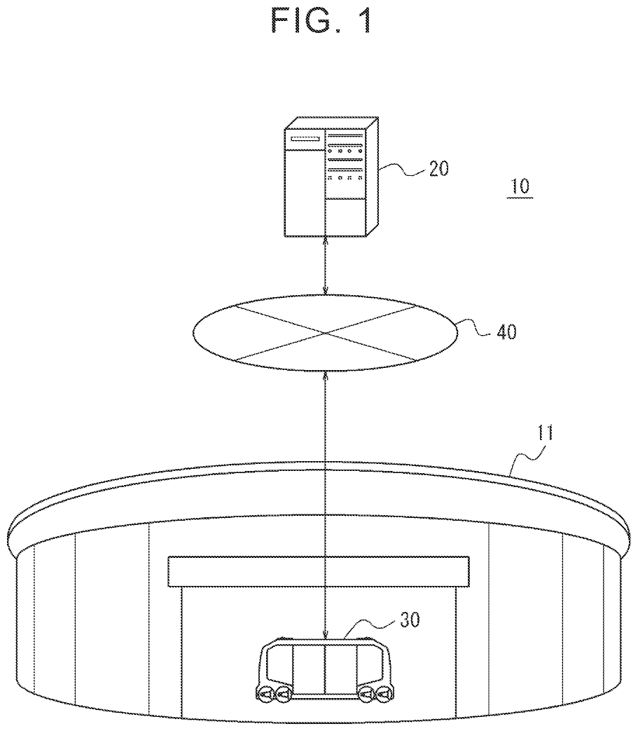

The configuration of a mobility dispatch system 10 according to this embodiment will be described with reference to FIG. 1.

The mobility dispatch system 10 includes a control device 20 and a power supply mobility 30. The control device 20 can communicate with the power supply mobility 30 via the network 40.

The control device 20 is a computer installed in a facility such as a data center. The control device 20 is, for example, a server belonging to a cloud computing system or other computing systems. The control device 20 is operated by a business that provides charging services.

The power supply mobility 30 is a mobility having an external power supply function. The external power supply function is a function that supplies power to an electronic device used by a user, such as a mobile phone, a smartphone, a tablet, or a PC. PC is an abbreviation for personal computer. The power supply mobility 30 is, for example, a vehicle equipped with a large capacity battery, a generator, or both. The vehicle itself may be any type of motor vehicle, such as, for example, a gasoline vehicle, a diesel vehicle, a hydrogen vehicle, a HEV, a PHEV, a BEV, or an FCEV. “HEV” is an abbreviation for hybrid electric vehicle. “PHEV” is an abbreviation for plug-in hybrid electric vehicle. “BEV” is an abbreviation for battery electric vehicle. “FCEV” is an abbreviation for fuel cell electric vehicle. Although the power supply mobility 30 is an AV in this embodiment, it may be operated by a driver, or its operation may be automated to any level. AV stands for autonomous vehicle. The level of autonomous driving is, for example, one of levels 1 to 5 in the SAE leveling, for example. “SAE” is an abbreviation for Society of Automotive Engineers. The power supply mobility 30 may be a MaaS dedicated vehicle. MaaS is an abbreviation for Mobility as a Service.

The network 40 includes the Internet, at least one WAN, at least one MAN, or any combination thereof. WAN is an abbreviation for wide area network. MAN is an abbreviation for metropolitan area network. The network 40 may include at least one wireless network, at least one optical network, or any combination thereof. The wireless network is, for example, an ad hoc network, a cellular network, a wireless LAN, a satellite communication network, or a terrestrial microwave network. The term “LAN” is an abbreviation for “local area network”.

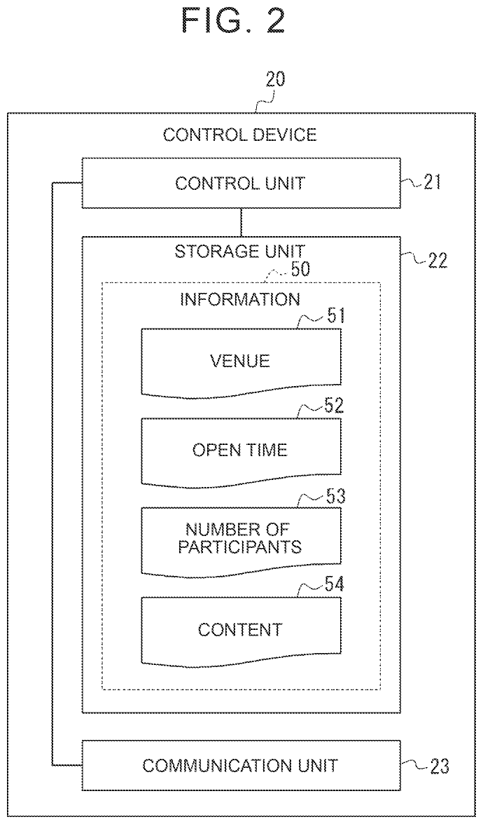

The outline of the present embodiment will be described with reference to FIGS. 1 and 2.

The control device 20 obtains information 50 regarding an event held within a certain area 11 using the control unit 21. Area 11 is, for example, an event venue such as an arena. In this embodiment, the event is an event held individually at a booth of an exhibition, a trade fair, a food event, or a product exhibition, but it may also be an exhibition, a trade fair, a food event, or a product exhibition itself.

Based on the acquired information 50, the control device 20 causes the control unit 21 to determine a location from among a plurality of locations within the area 11 to which the power supply mobility 30 is to be dispatched. The plurality of locations includes, for example, a location where an event is held, such as a booth at an exhibition, trade show, food event, or product fair. The plurality of locations may further include a rest area with only chairs.

The control device 20 causes the control unit 21 to perform a process of dispatching the power supply mobility 30 to the determined location. As a result, the power supply mobility 30 moves to the location determined by the control unit 21 and supplies power to the electronic device used by the user as a charging service.

According to this embodiment, it is possible to meet the charging needs that exist in the area 11 where the event is held. For example, by dispatching the power supply mobility 30 to a place where the need for charging is expected to increase at an event venue, the need for charging can be fully met.

The interior space of the power supply mobility 30 may be utilized as a space where the user can use a PC, a desk work space, or a rest space. For example, the power supply mobility 30 may be dispatched to a rest area at an event venue, and the internal space of the power supply mobility 30 may be utilized as a temporary PC space. According to this example, the user can take a break in the power supply mobility 30 while charging the PC.

A bus that transports passengers between the event venue and the nearest station may be utilized as the power supply mobility 30. For example, passenger transportation needs are estimated based on the bus occupancy rate, changes in the number of people entering/leaving the venue over time, congestion at the nearest station, or any combination of these, and it is expected that there will be a surplus of buses. The surplus bus may be utilized as the power supply mobility 30. According to this example, surplus buses can be effectively utilized.

The power supply mobility 30 may be dispatched only during times when the need for charging increases, such as during the daytime. During times when the number of people taking a break increases, such as during lunch time, the power supply mobility 30 may be preferentially dispatched to the rest area.

When visitors are invited to use the charging service at a specific location, such as at the entrance of an event venue, the power supply mobility 30 may be preferentially dispatched to that specific location.

When the location where the visitors are gathered is identified by referring to the location information obtained from the GNSS receiver installed in the electronic device of the visitor, the power supply mobility 30 is preferentially dispatched to the identified location. GNSS is an abbreviation for global navigation satellite system. The GNSS is, for example, GPS, QZSS, BDS, GLONASS, or Galileo. GPS is an abbreviation for Global Positioning System. The “QZSS” is an abbreviation for quasi-zenith satellite system. The satellites of the QZSS are referred to as quasi-zenith satellites. BDS stands for BeiDou Navigation Satellite System. GLONASS is an abbreviation for Global Navigation Satellite System.

In this embodiment, the information 50 regarding the event includes various information such as the event location 51, event time 52, number of participants 53, and content 54. It is desirable that the information 50 regarding the event includes not only past and present information but also future information. That is, it is desirable that the control device 20 determine the location to dispatch the power supply mobility 30 based on such future information.

The configuration of the control device 20 according to the present embodiment will be described with reference to FIG. 2.

The control device 20 includes a control unit 21, a storage unit 22, and a communication unit 23.

The control unit 21 includes at least one processor, at least one programmable circuit, at least one dedicated circuit, or any combination thereof. The processor is a general-purpose processor such as a CPU or a GPU, or a dedicated processor specialized for a specific process. The term “CPU” is an abbreviation for “central processing unit”. The term “GPU” is an abbreviation for “graphics processing unit”. The programmable circuit is, for example, an FPGA. The term “FPGA” is an abbreviation for “field-programmable gate array”. The dedicated circuit is, for example, an ASIC. The term “ASIC” is an abbreviation for “application specific integrated circuit”. The control unit 21 performs processes related to the operation of the control device 20 while controlling each unit of the control device 20.

The storage unit 22 includes at least one semiconductor memory, at least one magnetic memory, at least one optical memory, or any combination thereof. The semiconductor memory is, for example, a RAM, a ROM, or a flash memory. The term “RAM” is an abbreviation for “random access memory”. The term “ROM” is an abbreviation for “read-only memory”. The RAM is, for example, an SRAM or a DRAM. The term “SRAM” is an abbreviation for “static random access memory”. The term “DRAM” is an abbreviation for “dynamic random access memory”. The ROM is, for example, an EEPROM. The term “EEPROM” is an abbreviation for “electrically erasable programmable read-only memory”. The flash memory is, for example, an SSD. “SSD” is an abbreviation for solid-state drive. The magnetic memory is, for example, an HDD. “HDD” is an abbreviation for hard disk drive. The storage unit 22 functions as, for example, a main storage device, an auxiliary storage device, or a cache memory. The storage unit 22 stores the information used for the operation of the control device 20 and the information obtained through the operation of the control device 20. In this embodiment, the storage unit 22 stores at least information 50 regarding events.

Communication unit 23 includes at least one communication module. The communication module is, for example, a module compatible with a wired LAN communication standard such as Ethernet (registered trademark) or a wireless LAN communication standard such as IEEE802.11. “IEEE” is an abbreviation for Institute of Electrical and Electronics Engineers. The communication unit 23 communicates with the power supply mobility 30. The communication unit 23 receives information used for the operation of the control device 20, and transmits information obtained through the operation of the control device 20.

The function of the control device 20 is realized by executing a control program according to the present embodiment with the processor serving as the control unit 21. That is, the function of the control device 20 is realized by software. The control program causes the computer to perform the operation of the control device 20 so that the computer functions as the control device 20. That is, the computer functions as the control device 20 by performing the operation of the control device 20 in accordance with the control program.

The program can be stored in a non-transitory computer-readable medium. The non-transitory computer-readable medium is, for example, a flash memory, a magnetic recording device, an optical disc, an opto-magnetic recording medium, or a ROM. The distribution of the program is carried out, for example, by selling, transferring, or renting a portable medium such as an SD card, a DVD, or a CD-ROM in which the program is stored. The term “SD” is an abbreviation for “secure digital”. The term “DVD” is an abbreviation for “digital versatile disc”. The term “CD-ROM” is an abbreviation for “compact disc read-only memory”. The program may be stored in the storage of the server and transferred from the server to other computers to distribute the program. The program may be provided as a program product.

The computer temporarily stores the program stored in the portable medium or the program transferred from the server in the main storage device, for example. The computer then causes the processor to read the program stored in the main storage device, and causes the processor to execute processes in accordance with the read program. The computer may read the program directly from the portable medium and execute processes in accordance with the program. The computer may execute the processes in accordance with the received program each time the program is transferred from the server to the computer. The processes may be executed by a so-called ASP service that realizes the function only by execution instruction and result acquisition without transferring the program from the server to the computer. The term “ASP” is an abbreviation for “application service provider”. The program includes information that is used for processing by electronic computers and equivalent to a program. For example, data that is not a direct command to a computer but has the property of defining the processing of the computer corresponds to the “data equivalent to a program”.

A part or all of the functions of the control device 20 may be realized by a programmable circuit or a dedicated circuit as the control unit 21. That is, a part or all of the functions of the control device 20 may be realized by hardware.

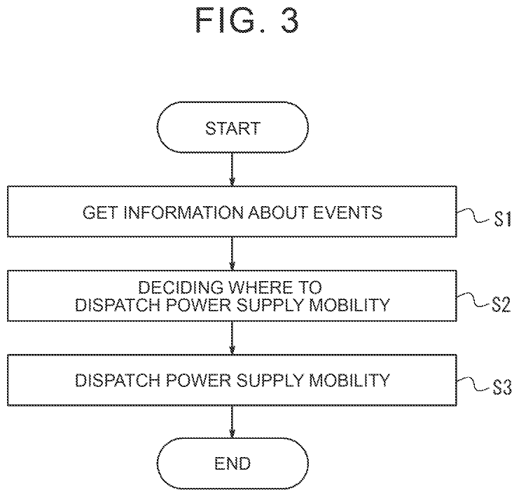

The operation of the control device 20 according to this embodiment will be described with reference to FIG. 3. The operation of the control device 20 corresponds to the control method according to this embodiment. That is, the control method according to this embodiment includes steps S1 to S3 shown in FIG. 3.

In S1, the control unit 21 acquires information 50 regarding the event. Specifically, the control unit 21 reads information 50 regarding the event from the storage unit 22. Information 50 regarding the event is stored in the storage unit 22 in advance. Alternatively, the information 50 regarding the event may be acquired from an external storage via the communication unit 23 and then stored in the storage unit 22.

In S2, the control unit 21 determines a location to which the power supply mobility 30 is to be dispatched from among a plurality of locations within the area 11, based on the information 50 acquired in S1. Specifically, the control unit 21 determines the location to which the power supply mobility 30 is dispatched according to the event location 51, event time 52, number of participants 53, or content 54 included in the information 50 acquired in S1.

A specific example of the process of S2 will be explained.

In the first example, the information 50 regarding the event includes the location of each location where the event is held, which is included in a plurality of locations, as the event location 51, and also includes the location where the power supply equipment is installed within the area 11. The power supply equipment is equipment that has the function of supplying power to electronic devices used by users. The power supply equipment includes, for example, a utility power outlet, a high capacity battery, a generator, or any combination thereof. Based on the information 50 acquired in S1, the control unit 21 determines the location to which the power supply mobility 30 is to be dispatched by comparing the distances of the locations where the event is held from the power supply equipment. For example, the control unit 21 preferentially selects a location far from the power supply equipment as the location to which the power supply mobility 30 is dispatched.

As a modification of the first example, the control unit 21 may predict the number of people who will participate in an event held at each location included in the plurality of locations, based on the information 50 acquired in S1. The control unit 21 may determine the location to which the power supply mobility 30 is to be dispatched by comparing the predicted number of people. For example, the control unit 21 may refer to statistical data, analyze the ease with which users gather at each location in the event venue in the past, and preferentially select locations where users easily gather as locations to which the power supply mobility 30 is dispatched.

In the second example, the information 50 regarding the event includes, as the event time 52, a time frame in which the event is held at each location included in the plurality of locations. The control unit 21 predicts the number of people who will participate in the event held at each location based on the information 50 acquired in S1. The control unit 21 compares the predicted number of people and determines the location to which the power supply mobility 30 is to be dispatched. For example, the control unit 21 refers to statistical data, analyzes the number of users in each time period in the past at the event venue, and preferentially selects the location where the event is held at a time when there are many users as the location to which the power supply mobility 30 will be dispatched.

In the third example, the information 50 regarding the event includes, as the number of participants 53, the number of users scheduled or predicted to participate in the event held at each location included in the plurality of locations. The control unit 21 predicts the number of people who will participate in the event held at each location based on the information 50 acquired in S1. The control unit 21 compares the predicted number of people and determines the location to which the power supply mobility 30 is to be dispatched. For example, the control unit 21 preferentially selects a location where an event with many users scheduled to participate is held as a location to which the power supply mobility 30 is dispatched.

In the fourth example, the information 50 regarding the event includes, as the content 54, the content of the event held at each location included in the plurality of locations. Based on the information 50 acquired in S1, the control unit 21 determines the location to which the power supply mobility 30 is to be dispatched by comparing the likelihood that a user will use an electronic device at an event held at each location. For example, the control unit 21 preferentially selects, as the location to which the power supply mobility 30 is to be dispatched, the locations where events are to be held and the user is likely to use the electronic device, such as events that require recording of minutes or events where there is a strong need for recording such as panel discussions.

In S3, the control unit 21 performs a process of dispatching the power supply mobility 30 to the location determined in S2. Specifically, the control unit 21 instructs the power supply mobility 30 to move to the location determined in S2 via the communication unit 23.

The present disclosure is not limited to the embodiment described above. For example, two or more blocks shown in the block diagram may be integrated, or a single block may be divided. Instead of executing two or more steps shown in the flowchart in chronological order according to the description, the steps may be executed in parallel or in a different order, depending on the processing capacities of the devices that execute the steps, or as necessary. Other changes may be made without departing from the scope of the present disclosure.

What is claimed is:

1. A control device comprising a control unit that acquires information about events to be held within a certain area, determines a location to which power supply mobility is to be dispatched from among a plurality of locations within the area based on the acquired information, and dispatching the power supply mobility to the determined location, wherein the power supply mobility is provided with a function of supplying power to an electronic device used by a user.

2. The control device according to claim 1, wherein:
the information includes positions of locations at which the events are to be held, included in the plurality of locations, and a position at which a power supply facility that is provided with a function of supplying power to the electronic device is installed within the area; and
the control unit determines the location to which the power supply mobility is to be dispatched by comparing distances of the locations at which the events are to be held from the power supply facility based on the information.

3. The control device according to claim 1, wherein:
the information includes contents of the events to be held at locations included in the plurality of locations; and
the control unit determines the location to which the power supply mobility is to be dispatched by comparing likelihoods that the user uses the electronic device at the events to be held at the locations based on the information.

4. The control device according to claim 1, wherein the control unit determines the location to which the power supply mobility is to be dispatched by predicting respective numbers of people who participate in the events to be held at locations included in the plurality of locations based on the information and comparing the predicted numbers of people.

5. A control method comprising:
acquiring, by a control unit, information about events to be held in a certain area;
determining, by the control unit, a location to which power supply mobility is to be dispatched from among a plurality of locations within the area based on the acquired information, the power supply mobility being provided with a function of supplying power to an electronic device used by a user; and
performing, by the control unit, a process of dispatching the power supply mobility to the determined location.
